(19) United States
(12) Patent Application Publication
(10) Pub. No.: US 2025/0135760 A1
(43) Pub. Date: May 1, 2025

(54) STOCK OF A PROTECTIVE PACKAGING MATERIAL, METHOD FOR MANUFACTURING A PROTECTIVE PACKAGING PRODUCT, AND PROTECTIVE PACKAGING PRODUCT

(71) Applicant: Storopack Hans Reichenecker GmbH, Metzingen (DE)

(72) Inventors: Anthony Mahé, Pont Saint Martin (FR); Charles Poisson, Cholet (FR)

(21) Appl. No.: 18/701,744

(22) PCT Filed: Oct. 27, 2021
(86) PCT No.: PCT/EP2021/079877

§ 371 Date: Apr. 16, 2024

(51) Int. Cl. B32B 29/00; B32B 3/14; B32B 3/28; B32B 5/18; B32B 37/22; B65D 65/40; B65D 81/133

(52) U.S. Cl. CPC B32B 29/007; B32B 3/14; B32B 3/28; B32B 5/18; B32B 37/22; B65D 65/403; B65D 81/133; B32B 2305/022; B32B 2553/02

(57) ABSTRACT

A stock of a protective packaging material comprises foamed polysaccharide material. It is suggested that the stock comprises a plurality of essentially and generally flat panels each having at least a straight side edge, wherein adjacent panels are connected to each other at their common straight side edges by means of a hinge portion and are folded relative to each other such that they form a stack of essentially parallel panels.

### Specification

The present invention relates to a stock of a protective packaging material, a method for manufacturing a protective packaging product, and protective packaging products according to the preambles of the independent claims.

WO 2020/023520 A1 discloses a compostable or recyclable packaging wrap comprising a layer that is primarily formed of starch and that is flexible such that the layer can be rolled. The rolled layer forms a stock of protective packaging material which can be unrolled, and portions of the layer can be separated from the remainder by means of perforation lines. Furthermore, it is known from the market to manufacture specifically shaped protective packaging products by stacking polyethylene layers one above the other, and by fixing the polyethylene layers to each other by heat welding. Such protective packaging products are used to cushion an object in order to protect this object for example against shock loads during transport.

It is an object of the present invention to provide a stock of protective packaging material which can be easily transported and used, and to provide a method for manufacturing a protective packaging product which can easily be applied, and to provide protective packaging products which have superior cushioning properties.

This object is achieved by means of a stock of protective packaging material, a method for manufacturing a protective packaging product and protective packaging products having the features of the independent claims. Further embodiments are given in the dependent claims.

Since the protective packaging material of the stock according to the invention does not need to be rolled or wound up, the protective packaging material does not need to have an increased flexibility but instead can be rather stiff which allows the protective packaging material to have superior cushioning properties with respect to the prior art material. Furthermore, the protective packaging material provided by the inventive stock may be essentially flat, whereas the protective packaging material of the prior art tends to be curved because of the shape memory of the material. By consequence, the protective packaging material provided by the inventive stock can easily be processed.

More specifically, the invention proposes a stock of a protective packaging material. Such a stock may be provided for example at a manufacturing site in order to manufacture a protective packaging product using the protective packaging material of the stock. Alternatively, the stock may be provided for example at a location from where the article has to be shipped. In the latter case, the protective packaging material of the stock can be directly used for example in order to be wrapped around the article to be shipped and protected.

The protective packaging material according to the invention comprises foamed polysaccharide material, for example a starch foam, and therefore is biodegradable and recyclable. Other polysaccharide materials are cellulose, pullulanes, alginates, chitin, chitosanes, xanthane, dextrane, glycogen and their derivatives such as for example esters or ethers. Additives can be added, such as biodegradable polymers as PVA (polyvinyl Alcohol), Fatty Acid, polyhydroxyalcanoates (PHA), and/or polyactic acid (PLA).

The stock comprises a plurality of essentially and generally flat panels each having at least a straight side edge. The term “generally flat” means that the panels as a whole are essentially flat, but this does not exclude, as will be shown hereinbelow, that the panels within themselves are structured, for example by means of corrugations. Adjacent panels are connected to each other at their common straight side edges by means of a hinge portion and are folded relative to each other such that they form a stack of essentially parallel panels. This means that the stack comprises at least two adjacent panels.

In a further embodiment the flat panels are quadrangular when seen from above. This allows to create a stack of zigzag folded protective packaging material where the hinge portions are located at opposite side edges of a panel. By consequence, the cross-section of the stack also is quadrangular which saves space in transport and storage compared to the circular cross-section of the prior art. Also, it is very easy to draw the protective packaging material out of the stack because it simply can be drawn from the top of the stack without the necessity of a specific holding means, for example an axle, for holding the stack as with the prior art.

In a further particularly preferred embodiment the panels comprise a plurality of corrugations. This increases the stiffness and the thickness of the panels and thus further improves the cushioning properties. Such an increment of stiffness is not possible with a material that has to be wound up. Especially for technical protective packaging, for example for protecting white goods, it is needed to provide increased shock absorption properties. With the inventive plurality of corrugations it is possible to increase the stiffness without increasing the density of the protective packaging material to more than 20 kg/m³.

In a further embodiment a longitudinal axis of the plurality of corrugations is parallel to a side edge of the panel. This provides advantages when the protective packaging material is manufactured by extrusion through an extrusion nozzle.

In a further embodiment the plurality of corrugations is not parallel to any of the side edges of the panel. This allows to further increase the stiffness of the protective packaging material if two panels are superposed one above the other, the longitudinal axis of the corrugations of one panel not being parallel to the longitudinal axis of the corrugations of the other panel.

In a further embodiment at least one hinge portion is formed by a depression, preferably by a cut, which at least regionally has a depth which is smaller than the thickness of the panels. Such hinge portions can easily be manufactured. Preferably, the extension of the depression is at least approximately half of the thickness of the protective packaging material, more preferably approximately ¾ of the thickness. The depression preferably is created by ultrasonic cutting.

In a further embodiment the stock comprises at least a first panel connected to a second panel by means of a first hinge portion formed by a first depression and a third panel connected to the second panel by means of a second hinge portion formed by a second depression, the first depression being oriented in an opposite direction than the second depression. In other words, the orientations of the depressions are alternating, which helps to create a zigzag folding of the protective packaging material.

In a further embodiment the panels are formed by a layered structure comprising a first layer comprising a 3D foamed polysaccharide material and a second 2D layer to which the first layer is attached. While it is clear that in the real physical world there does not exist any 2D element, in the context of the present invention the term “2D layer” is to be seen in contrast to the term “3D layer”. A 3D layer has a discrete thickness, which in the present case is provided essentially by the foamed polysaccharide material. In contrast hereto, a 2D layer is a very thin layer, such as a film or a sheet. The thickness of the 2D layer may be approximately one order of magnitude lower than the thickness of the 3D layer.

With the inventive stock the foamed polysaccharide material may be protected by the second 2D layer against harmful influences, and the stiffness of the protective packaging material provided by the stock can be increased.

In a further embodiment the first layer of a panel comprises a plurality of discrete 3D foamed polysaccharide material patches in a side by side arrangement and/or in a stacked arrangement. In case of a side-by-side arrangement of the polysaccharide material patches, the share of polysaccharide material in the protective packaging material can be reduced, which reduces costs. Furthermore, the material patches may be arranged at such locations within a panel which are best suitable for protecting a specific product. In case of a stacked arrangement of the polysaccharide material patches, the thickness of a panel can be increased and therefore its cushioning properties can be enhanced.

In a further embodiment the layered structure comprises a third 2D layer, the first layer being arranged between the second and the third layer. Such an arrangement provides a protective packaging material in the form of a sandwich material comprising a core comprising the first 3D layer of foamed polysaccharide material and two cover layers attached to the core formed by the second and third 2D layers. Such a sandwich protective packaging material has a further increased stiffness, and the core material is protected by means of the cover layers against mechanical and chemical influences.

The second and/or third layers can be attached to the first layer by means of a polysaccharide coating or by means of a polyethylene coating or by means of a biodegradable film such as PBAT. A polysaccharide coating may comprise or be essentially made of starch or microcrystalline cellulose fibers. The second and/or third layers preferably are paper weldable, for example by ultrasonic welding. Furthermore, the second and/or third layers may comprise a printed surface optic, such as a logo, use information, a QR code providing information about the manufacturer of the protective packaging material, of the shipping company, and/or of the manufacturer of the object which is protected by the protective packaging material.

In a further embodiment at least one cover layer comprises a paper or cardboard material. Paper and cardboard are also biodegradable and recyclable materials, such that an overall recyclable and biodegradable material is created. Adherence of the cover layer to the core can be easily provided by water moisture.

In a further embodiment the hinge portion is formed by at least one of the second and third layer. This facilitates folding adjacent panels relative to each other, because the second and/or the third layer due to the 2D structure are more flexible than the first 3D layer made of polysaccharide foam. However, in an alternative embodiment, the hinge portion may additionally comprise also the first 3D layer made of polysaccharide foam. In order to provide the necessary flexibility, the first 3D layer may be compressed to a lower thickness at the location of the hinge portion.

In a further embodiment the stock comprises at least a first panel connected to a second panel by means of a first hinge portion and a third panel connected to the second panel by means of a second hinge portion, wherein the first and the second hinge portions are arranged at adjacent side edges of the second panel. This arrangement allows to create a box type protective packaging product from a plurality of unitarily connected panels.

The invention also provides a method for manufacturing a protective packaging product, comprising the following steps: a. providing a first stock of a first protective packaging material according to at least one of the above-mentioned embodiments; b. providing a second stock of a second protective packaging material according to at least one of the above-mentioned embodiments; c. unfolding the first protective packaging material to a first continuous layer and the second protective packaging material to a second continuous strip; d. laminarily attaching the second layer to the first strip. The method according to the invention thus allows to create a protective packaging material having at least two layers and which thus provides increased stiffness and thickness and thus improved cushioning properties.

In a further embodiment the first layer and the second layer are arranged relative to each other such that the hinge portions between the panels of the first layer are not at the same position as the hinge portions between the panels of the second strip. The cushioning material therefore has no portions having a particularly reduced stiffness, thus providing good cushioning properties.

The invention also proposes a protective packaging product manufactured by means of a method as explained above. The first layer comprises first corrugations with a first longitudinal axis and the second layer comprises second corrugations with a second longitudinal axis, the first longitudinal axis and the second longitudinal axis being not parallel to each other. Such a protective packaging product has a high stiffness and therefore provides very good cushioning properties.

The invention also proposes a further protective packaging product manufactured from a protective packaging material provided by a stock as explained above. The protective packaging product may comprise a shaped recess in adjacent panels forming a cavity adapted to receive an article to be protected when the adjacent panels are folded upon each other. The recesses can be formed in each panel, for example by ultrasonic cutting, such that when the panels are superposed, a 3D volume cushioning system is provided.

Embodiments of the invention are now described in further detail with reference to the attached drawing. In the drawing is shown by

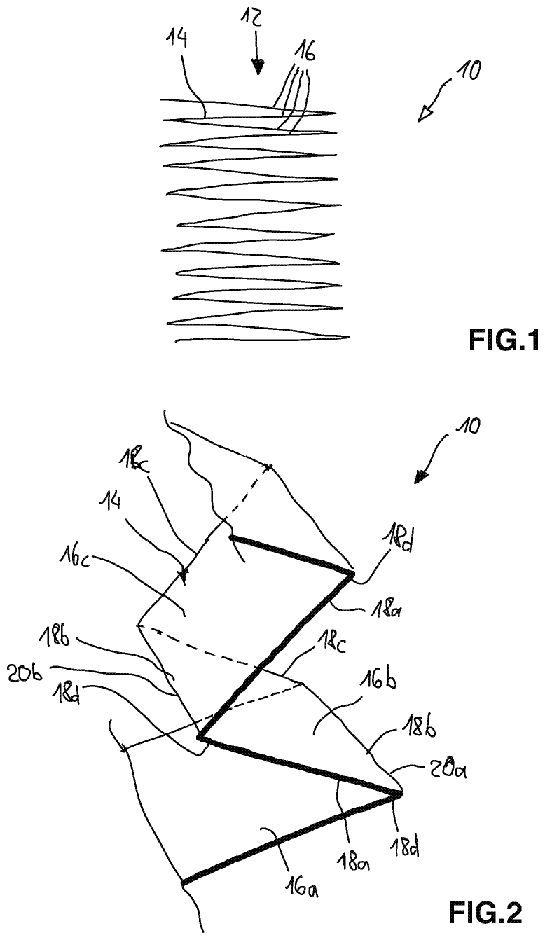

FIG. 1 a schematic sectional side view of a stock of protective packaging material comprising a stack of zigzag folded protective packaging material comprising a foamed polysaccharide material;

FIG. 2 a schematic perspective view of a portion of the protective packaging material of FIG. 1 when partially unfolded;

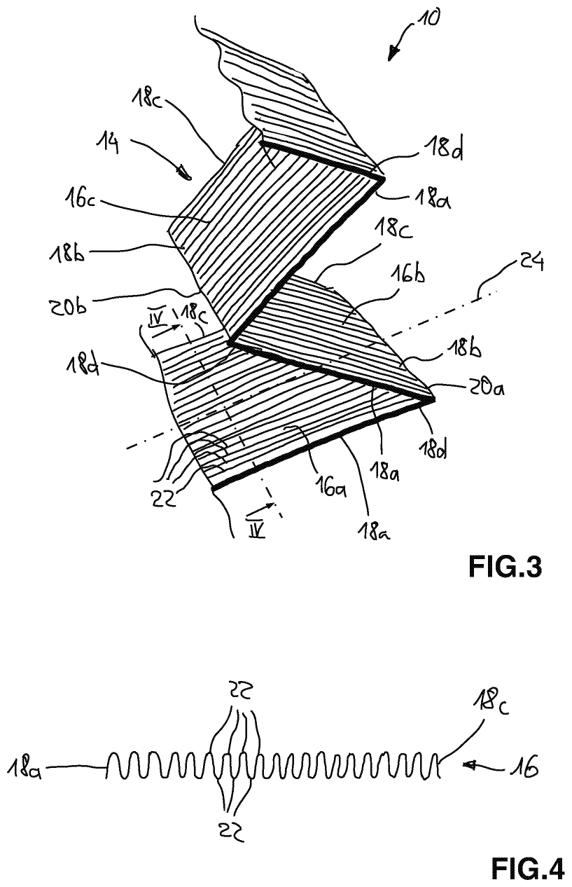

FIG. 3 a schematic perspective view similar to FIG. 2 of a portion of a further embodiment of a protective packaging material when partially unfolded;

FIG. 4 a cross sectional view along line IV-IV of FIG. 3;

FIG. 5 a schematic view from above onto a panel type protective packaging product comprising a foamed polysaccharide material;

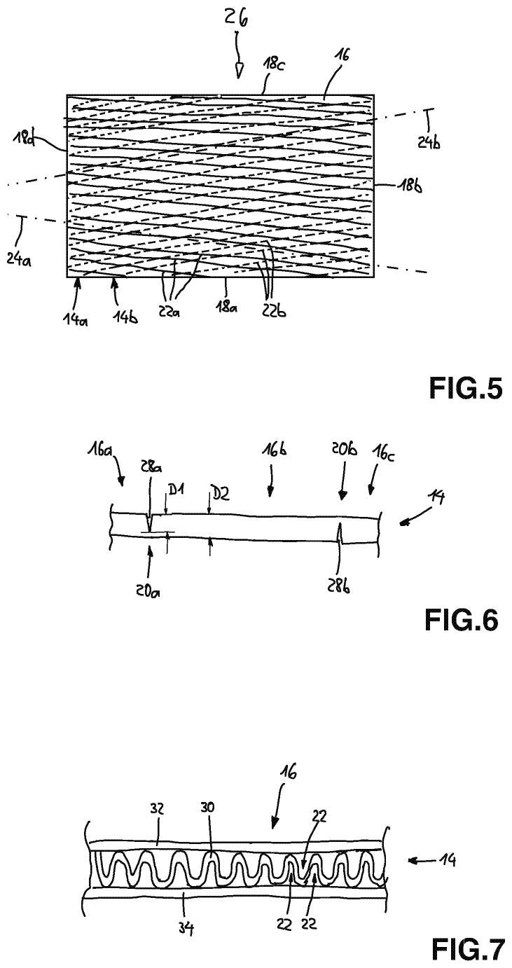

FIG. 6 a schematic cross-section through a portion of the protective packaging material of FIG. 1 showing hinge portions between adjacent panels;

FIG. 7 a schematic cross-section of a further embodiment of panels of a protective packaging material having a first 3D core layer and a second and a third 2D cover layer;

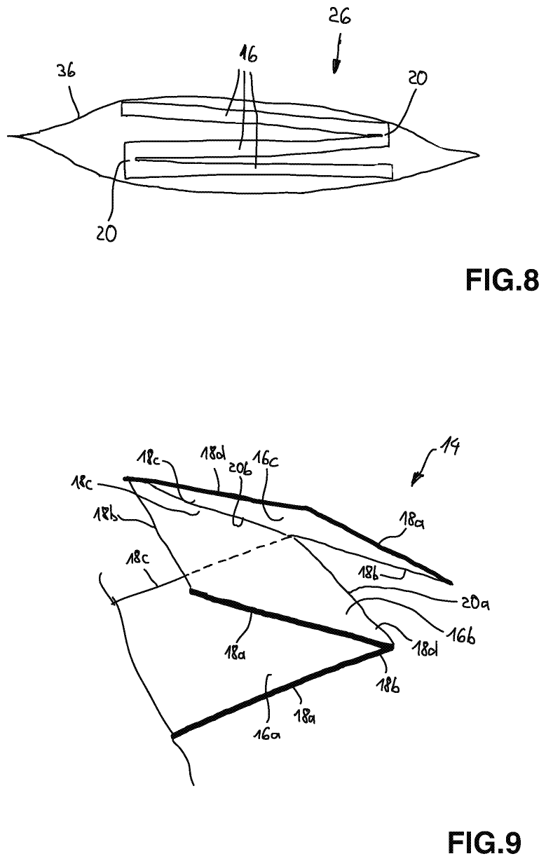

FIG. 8 a cushioning pad using 3 panels of the protective packaging material of FIG. 1;

FIG. 9 a schematic perspective view of a portion of a further embodiment of a protective packaging material which may be provided by a stock as shown in FIG. 1;

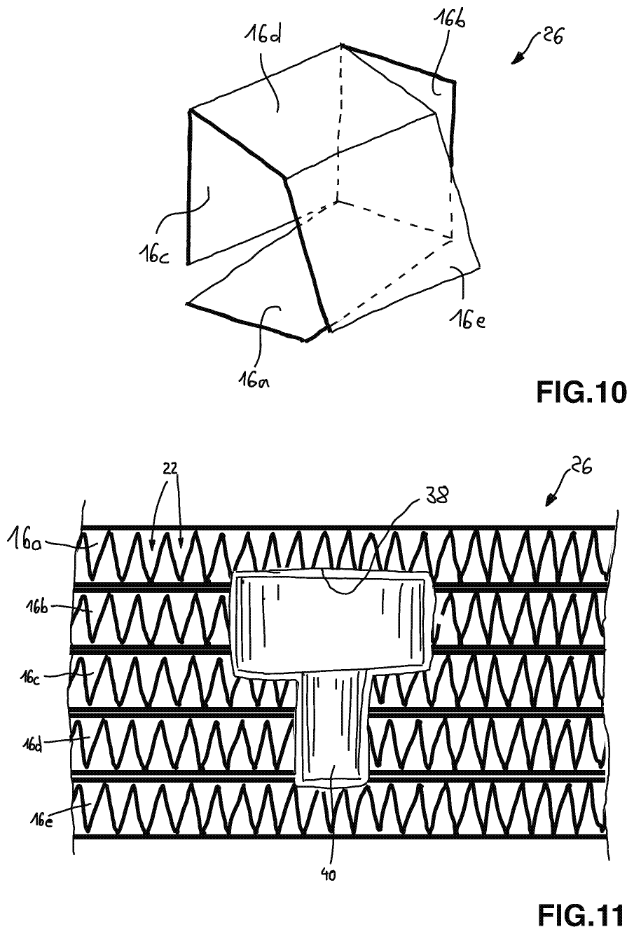

FIG. 10 a schematic perspective view of a box type protective packaging product in an intermediate fold state formed by the protective packaging material of FIG. 9;

FIG. 11 a 3D volume cushioning system formed by a plurality of panels using the protective packaging material of FIG. 3;

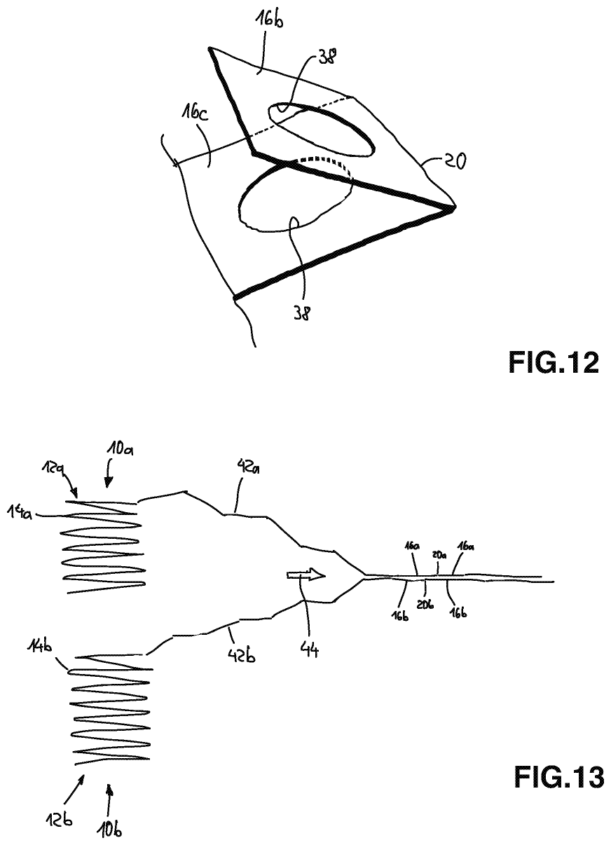

FIG. 12 a portion of the protective packaging material used for forming the 3D volume cushioning system of FIG. 11 in partially unfolded condition;

FIG. 13 two stacks of zigzag folded protective packaging material when used for providing a two-layer protective packaging product as shown in FIG. 5;

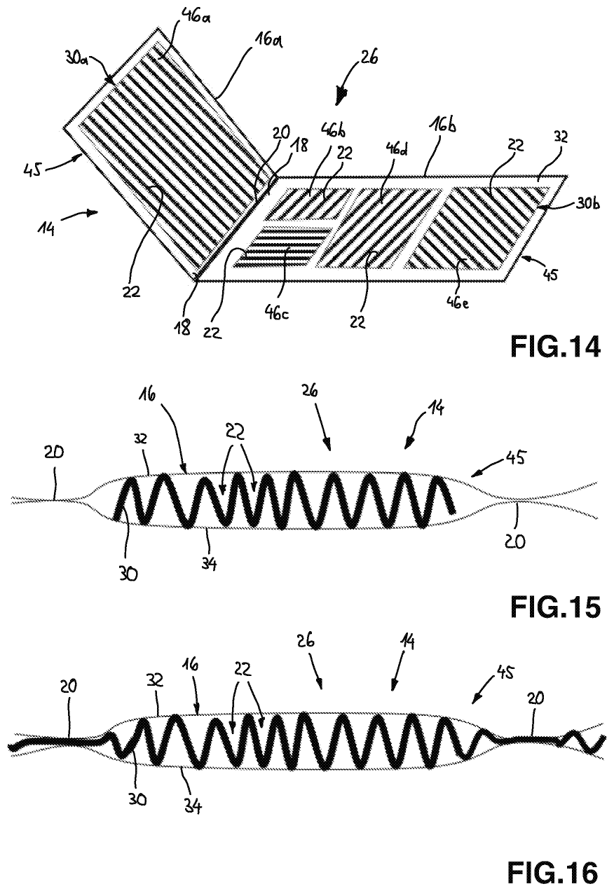

FIG. 14 a schematic perspective view of a portion of a further embodiment of a protective packaging material which may be provided by a stock as shown in FIG. 1;

FIG. 15 a schematic cross-section of a further embodiment of a panel of a protective packaging material having a first 3D core layer and a second and a third 2D cover layer;

FIG. 16 a schematic cross-section of a further embodiment of a panel of a protective packaging material having a first 3D core layer and a second and a third 2D cover layer; and

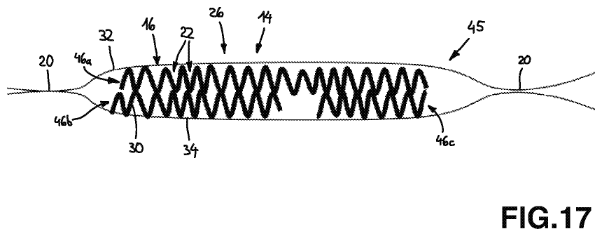

FIG. 17 a schematic cross-section of a further embodiment of a panel of a protective packaging material having a first 3D core layer and a second and a third 2D cover layer.

In the following detailed description functionally equivalent elements and regions are designated with the same reference numerals. For the sake of clarity not in all figures all possible reference numerals are shown. Moreover, reference numerals with or without indices a, b, c, . . . sometimes are used interchangeably. The indices a, b, c, . . . are mainly used where it appears to be helpful to distinguish between specific elements or portions.

In FIGS. 1 and 2, a stock of protective packaging material is generally designated with reference numeral 10. It comprises a stack 12 of protective packaging material 14. The protective packaging material 14 comprises foamed polysaccharide material, for example a starch foam, and therefore is biodegradable and recyclable. Other polysaccharide materials are cellulose, lignin, pullulanes, alginates, chitin, chitosanes, natural rubbers, rosinic acid, dextrin or proteins such as gluten, zein, casein, collagen, gelatin, phospholipids, caseins and their derivatives such as for example esters or ethers. Additives can be added, such as biodegradable polymers as PVA (polyvinyl Alcohol), Fatty Acid, polyhydroxyalcanoates (PHA), and/or polyactic acid (PLA).

The stack 12 is formed by a plurality of essentially and generally flat panels 16 each having an essentially quadrangular, namely rectangular shape with four straight side edges 18a-d. Adjacent panels 16a/16b and 16b/16c are connected to each other at their common straight side edges 18b and 18d, respectively, by means of respective hinge portions 20a and 20b, and are folded relative to each other such that they form the stack 12 as shown in FIG. 1.

In the embodiment of FIGS. 1 and 2, the panels 16 have an essentially smooth surface. In contrast hereto, in the embodiment of FIGS. 3 and 4, the panels 16 comprise a plurality of corrugations 22 providing a wave shape structure to the panels 16. The corrugations 22 can be formed when the protective packaging material is manufactured by extrusion through an extrusion nozzle. In the present exemplary embodiment, a longitudinal axis 24 of the corrugations 22 is essentially parallel to the side edges 18a and 18c of each panel 16.

In another exemplary embodiment which is shown in FIG. 5, a panel type protective packaging product 26 is shown which is formed using a web type protective packaging material 14 from a stack 12 as shown in FIG. 1. The panel 16 comprises two layers 14a and 14b of the web type protective packaging material 14 superposed to each other, as will be explained in further detail further below. In the embodiment of FIG. 5, the upper layer 14a of protective packaging material 14 comprises a plurality of first corrugations 22a (solid lines) with a first longitudinal axes 24a, and the lower layer 14b of protective packaging material 14 comprises a plurality of second corrugations 22b (dashed lines) with a second longitudinal axis 24b. As can easily be seen from FIG. 5, the first longitudinal axis 24a and the second longitudinal axes 24b are not parallel to each other and are not parallel to the side edges 18a and 18c of the panel 16.

FIG. 6 shows an exemplary embodiment of the hinge portions 20 connecting the panels 16a-c of the web type protective packaging material 14. The hinge portions 20a-b may be formed by a depression 28a-b, preferably by a cut, which may be provided by ultrasonic cutting. The extension D1 of the depressions 28a-b is more than approximately half of the thickness D2 of the protective packaging material 14, in the present exemplary embodiment even more than approximately ¾ of the thickness D2.

As can be seen from FIG. 6, a first panel 16a is connected to a second panel 16b by means of a first hinge portion 20a formed by a first depression 28a. A third panel 16c is connected to the second panel 16b by means of a second hinge portion 20b formed by a second depression 28b. The first depression 28a is oriented in an opposite direction (downwardly) than the second depression 28b (upwardly).

In the exemplary embodiment shown in FIG. 7 the panels 16 of the protective packaging material 14 are formed by a sandwich material comprising a first layer 30 comprising a 3D foamed polysaccharide material, a second 2D layer 32 and a third 2D layer 34, which are attached by means of an adhesive to the first layer 30. The adhesive may be provided by means of a polysaccharide coating or by means of a polyethylene coating or by means of a biodegradable film such as PBAT. A polysaccharide coating may comprise or essentially be made of starch or microcrystalline cellulose fibers. The second and/or third layers 32 and 34 preferably are paper weldable, for example by ultrasonic welding. Furthermore, the second and/or third layers 32 and 34 may comprise a printed surface optic, such as a logo, use information, a QR code providing information about the manufacturer of the protective packaging material, of the shipping company, and/or of the manufacturer of the object which is protected by the protective packaging material 14 One of the second and third 2D layers 32 and 34 or second and third 2D layers 32 and 34 may comprise a paper or cardboard material. With the first layer 30 providing a core 30 and comprising a foamed polysaccharide material, more preferably starch, the adhesive may be starch, too, which may be obtained by simply applying moisture to the core 30.

FIG. 8 shows an application example of three panels 16 of the inventive protective packaging material 14. It may be noted that the protective packaging material 14 may be of the type as shown in FIGS. 1 and 2, in FIGS. 3 and 4, in FIG. 5 or in FIG. 7. The three panels 16 are folded upon each other in a zigzag manner such that, seen from the side, as in FIG. 8, the panels 16 form approximately a Z. The three panels 16 are received within a closed pouch 36, for example a paper bag. The poach 36 with the three panels 16 inside forms a protective packaging product 26 in the form of a cushioning pad. Since the three panels 16 are still connected to each other by means of the hinge portions 20, they cannot move inside the pouch 36, which allows the cushioning properties of the protective packaging product 26 to be reliably provided in a variety of conditions. It is to be noted that, of course, in other examples the protective packaging product 26 may comprise more are less than three panels 16.

In the exemplary embodiment of FIG. 9, the protective packaging material 14 comprises a first panel 16a connected to a second panel 16b by means of a first hinge portion 20a. A third panel 16c is connected to the second panel 16b by means of a second hinge portion 20b. In contrast to the embodiments of FIGS. 1-3, in the embodiment of FIG. 9 the first hinge portion 20a and the second hinge portion 20b are arranged at adjacent side edges 18c and 18d of the second panel 16b. This may result in a box type protective packaging product 26 having a plurality of unitarily connected panels 16a-e, as is shown in FIG. 10.

In the exemplary embodiment of FIGS. 11 and 12, a protective packaging product 26 is manufactured from a protective packaging material 14 according to FIG. 3 provided by a stock 10 as shown in FIG. 1. The protective packaging product comprises a shaped recess 38 in adjacent panels 16a-e forming a cavity adapted to receive an article 40 to be protected when the adjacent panels 16a-e are folded upon each other.

A method for manufacturing the protective packaging product 26 of FIG. 5 is now explained with reference to FIG. 13. Two stocks 10a and 10b with stacks 12a and 12b of zigzag folded protective packaging material 14a and 14b are provided. The protective packaging materials 14a and 14b are then unfolded in order to form a first continuous layer 42a and a second continuous layer 42b. By means of a spray nozzle, which is symbolized by arrow 44, water is sprayed onto the lower surface of the upper continuous layer 42a and the upper surface of the lower continuous layer 42b. Then the layers 42a and 42b are laminarily attached to each other forming the protective packaging product 26 of FIG. 5. As can be seen from FIG. 13, the first layer 42a and the second layer 42b are arranged relative to each other such that the hinge portions 20a between the panels 16a of the first layer 42a are not at the same position as the hinge portions 20b between the panels 16b of the second layer 42b.

FIG. 14 shows a further embodiment of two adjacent panels 16a and 16b which are connected to each other by means of a hinge portion 20. While both panels 16a and 16b have the same width, the lengths are different from each other. Both panels 16a and 16b are formed by layered structures 45, each comprising a first 3D layer 30a and 30b, respectively, comprising a 3D foamed polysaccharide material having corrugations 22. The first 3D layers 30a and 30b are provided by a plurality of discrete 3D foamed polysaccharide material patches 46a-e, which are arranged in a side by side arrangement relative to each other and which are spaced from each other. Both panels 16a and 16b further comprise a same and unitary second layer 32 to which the first layers 30a-b with their patches 46a-e are attached. As can be seen from FIG. 14, the hinge portion 20 is solely formed in the second layer 32.

FIG. 15 shows a further embodiment of a panel 16 which is similar to the embodiment of FIG. 7. As can be seen from FIG. 15, the hinge portions 20 are solely formed in the second and third layers 32 and 34.

FIG. 16 shows a further embodiment of a panel 16 which is similar to the embodiment of FIG. 7. As can be seen from FIG. 16, the hinge portions 20 are formed by the first, second and third layers 30-34. To this effect, the first layer 30 normally comprising the corrugations 22 is compressed at the location of the hinge portions 20 such that it is essentially flat without any congregation at the location of the hinge portions 20.

FIG. 17 shows a further embodiment of a panel 16 which is similar to the embodiment of FIG. 7. As can be seen from FIG. 17, the first layer 30 comprises a plurality of foamed polysaccharide material patches 46a-c. While the patches 46b and 46c are in a stack arrangement relative to the patch 46a, they are in a side-by-side arrangement relative to each other.

1. A stock of a protective packaging material comprising foamed polysaccharide material, comprising a plurality of essentially and generally flat panels each having at least a straight side edge, wherein adjacent panels are connected to each other at their common straight side edges by means of a hinge portion and are folded relative to each other such that they form a stack of essentially parallel panels.

2. The stock of claim 1 wherein the flat panels are quadrangular.

3. The stock of claim 1 wherein the panels comprise a plurality of corrugations.

4. The stock of claim 3 wherein the plurality of corrugations is parallel to a side edge of the panel.

5. The stock of claim 3 wherein the plurality of corrugations is not parallel to any of the side edges of the panel.

6. The stock of claim 1 wherein at least one hinge portion comprises a depression, preferably by a cut, which at least regionally has a depth (D1) which is smaller than the thickness (D2) of the panels.

7. The stock of claim 6 wherein it comprises at least a first panel connected to a second panel by means of a first hinge portion comprising a first depression and a third panel connected to the second panel by means of a second hinge portion comprising a second depression, the first depression being oriented in an opposite direction than the second depression.

8. The stock of claim 1, wherein the panels are formed by a layered structure comprising a first layer comprising a 3D foamed polysaccharide material and a second 2D layer to which the first layer is attached.

9. The stock of claim 8, wherein the first layer of a panel comprises a plurality of discrete 3D foamed polysaccharide material patches in a side by side arrangement and/or in a stacked arrangement.

10. The stock of claim 8, wherein the layered structure comprises a third 2D layer, the first layer being arranged between the second and the third layers.

11. The stock of claim 8, wherein at least one of the second and the third layers comprises a paper or cardboard material.

12. The stock of claim 8, wherein the hinge portion is formed by at least one of the second and third layer.

13. The stock of claim 1 wherein it comprises at least a first panel connected to a second panel by means of a first hinge portion and a third panel connected to the second panel by means of a second hinge portion, wherein the first and the second hinge portions are arranged at adjacent side edges of the second panel.

14. A method for manufacturing a protective packaging product, comprising the following steps:
providing a first stock of a first protective packaging material according to claim 1;
providing a second stock of a second protective packaging material according to claim 1;
unfolding the first protective packaging material to a first continuous layer and the second protective packaging material to a second continuous layer;
laminarily attaching the second layer to the first layer.

15. The method of claim 14 wherein the first layer and the second layer are arranged relative to each other such that the hinge portions between the panels of the first layer are not at the same position as the hinge portions between the panels of the second layer.

16. A protective packaging product manufactured by the method of claim 1 wherein the first layer comprises first corrugations with a first longitudinal axis and the second layer comprises second corrugations with a second longitudinal axis, the first longitudinal axis and the second longitudinal axis being not parallel to each other.

17. A protective packaging product manufactured from a protective packaging material provided by the stock of claim 1.

18. The protective packaging product of claim 17, wherein it comprises a shaped recess in adjacent panels forming a cavity adapted to receive an article to be protected when the adjacent panels are folded upon each other.
